(19) United States
(12) Patent Application Publication
(10) Pub. No.: US 2025/0063582 A1
(43) Pub. Date: Feb. 20, 2025

(54) MULTI-CARRIER SCHEDULING FOR SIDELINK COMMUNICATIONS

(71) Applicant: QUALCOMM Incorporated, San Diego, CA (US)

(72) Inventors: Hui GUO, Beijing (CN); Shuanshuan WU, San Diego, CA (US); Seyedkianoush HOSSEINI, San Diego, CA (US); Kapil GULATI, Belle Mead, NJ (US); Tien Viet NGUYEN, Bridgewater, NJ (US); Anantharaman BALASUBRAMANIAN, San Diego, CA (US)

(21) Appl. No.: 18/719,562

(22) PCT Filed: Feb. 3, 2022
(86) PCT No.: PCT/CN2022/075313

§ 371 Date: Jun. 13, 2024

(51) Int. Cl. H04W 72/40; H04L 5/00; H04W 72/12; H04W 72/51

(52) U.S. Cl. CPC H04W 72/40; H04L 5/001; H04W 72/12; H04W 72/51

(57) ABSTRACT

Various aspects of the present disclosure generally relate to wireless communication. In some aspects, a user equipment (UE) may receive a configuration of a first resource pool associated with a first component carrier and a second resource pool associated with a second component carrier. The UE may receive an indication of a resource allocation associated with a sidelink communication, wherein the resource allocation is based at least in part on at least one of the first resource pool or the second resource pool. The UE may perform the sidelink communication in accordance with the resource allocation. Numerous other aspects are described.

### FIELD OF THE DISCLOSURE

Aspects of the present disclosure generally relate to wireless communication and to techniques and apparatuses for multi-carrier scheduling for sidelink communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications and access link communications, in accordance with the present disclosure.

FIG. 4 is a diagram illustrating an example of sidelink communications, in accordance with the present disclosure.

FIG. 5 is a diagram illustrating examples of carrier aggregation, in accordance with the present disclosure.

FIG. 6 is a diagram illustrating an example associated with multi-carrier scheduling for sidelink communications, in accordance with the present disclosure.

FIG. 7 is a diagram illustrating an example process performed, for example, by a UE, in accordance with the present disclosure.

FIG. 8 is a diagram illustrating an example process 800 performed, for example, by a network entity, in accordance with the present disclosure.

FIG. 9 is a diagram of an example apparatus for wireless communication, in accordance with the present disclosure.

FIG. 10 is a diagram of an example apparatus for wireless communication.

### SUMMARY

Some aspects described herein relate to a method of wireless communication performed by a user equipment (UE). The method may include receiving a configuration of a first resource pool associated with a first component carrier and a second resource pool associated with a second component carrier. The method may include receiving an indication of a resource allocation associated with a sidelink communication, wherein the resource allocation is based at least in part on at least one of the first resource pool or the second resource pool. The method may include performing the sidelink communication in accordance with the resource allocation.

Some aspects described herein relate to a method of wireless communication performed by a network entity. The method may include transmitting, to a UE, a configuration of a first resource pool associated with a first component carrier and a second resource pool associated with a second component carrier. The method may include transmitting, to the UE, an indication of a resource allocation associated with a sidelink communication, wherein the resource allocation is based at least in part on at least one of the first resource pool or the second resource pool.

Some aspects described herein relate to an apparatus for wireless communication at a UE. The apparatus may include a memory and one or more processors coupled to the memory. The one or more processors may be configured to receive a configuration of a first resource pool associated with a first component carrier and a second resource pool associated with a second component carrier. The one or more processors may be further configured to receive an indication of a resource allocation associated with a sidelink communication, wherein the resource allocation is based at least in part on at least one of the first resource pool or the second resource pool. The one or more processors may be further configured to perform the sidelink communication in accordance with the resource allocation.

Some aspects described herein relate to an apparatus for wireless communication at a network entity. The apparatus may include a memory and one or more processors coupled to the memory. The one or more processors may be configured to transmit, to a UE, a configuration of a first resource pool associated with a first component carrier and a second resource pool associated with a second component carrier. The one or more processors may be further configured to transmit, to the UE, an indication of a resource allocation associated with a sidelink communication, wherein the resource allocation is based at least in part on at least one of the first resource pool or the second resource pool.

Some aspects described herein relate to a non-transitory computer-readable medium that stores a set of instructions for wireless communication by a UE. The set of instructions, when executed by one or more processors of the UE, may cause the UE to receive a configuration of a first resource pool associated with a first component carrier and a second resource pool associated with a second component carrier. The set of instructions, when executed by one or more processors of the UE, may further cause the UE to receive an indication of a resource allocation associated with a sidelink communication, wherein the resource allocation is based at least in part on at least one of the first resource pool or the second resource pool. The set of instructions, when executed by one or more processors of the UE, may further cause the UE to perform the sidelink communication in accordance with the resource allocation.

Some aspects described herein relate to a non-transitory computer-readable medium that stores a set of instructions for wireless communication by a network entity. The set of instructions, when executed by one or more processors of the network entity, may cause the network entity to transmit, to a UE, a configuration of a first resource pool associated with a first component carrier and a second resource pool associated with a second component carrier. The set of instructions, when executed by one or more processors of the network entity, may further cause the network entity to transmit, to the UE, an indication of a resource allocation associated with a sidelink communication, wherein the resource allocation is based at least in part on at least one of the first resource pool or the second resource pool.

Some aspects described herein relate to an apparatus for wireless communication. The apparatus may include means for receiving a configuration of a first resource pool associated with a first component carrier and a second resource pool associated with a second component carrier. The apparatus may further include means for receiving an indication of a resource allocation associated with a sidelink communication, wherein the resource allocation is based at least in part on at least one of the first resource pool or the second resource pool. The apparatus may further include means for performing the sidelink communication in accordance with the resource allocation.

Some aspects described herein relate to an apparatus for wireless communication. The apparatus may include means for transmitting, to a UE, a configuration of a first resource pool associated with a first component carrier and a second resource pool associated with a second component carrier. The apparatus may further include means for transmitting, to the UE, an indication of a resource allocation associated with a sidelink communication, wherein the resource allocation is based at least in part on at least one of the first resource pool or the second resource pool.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

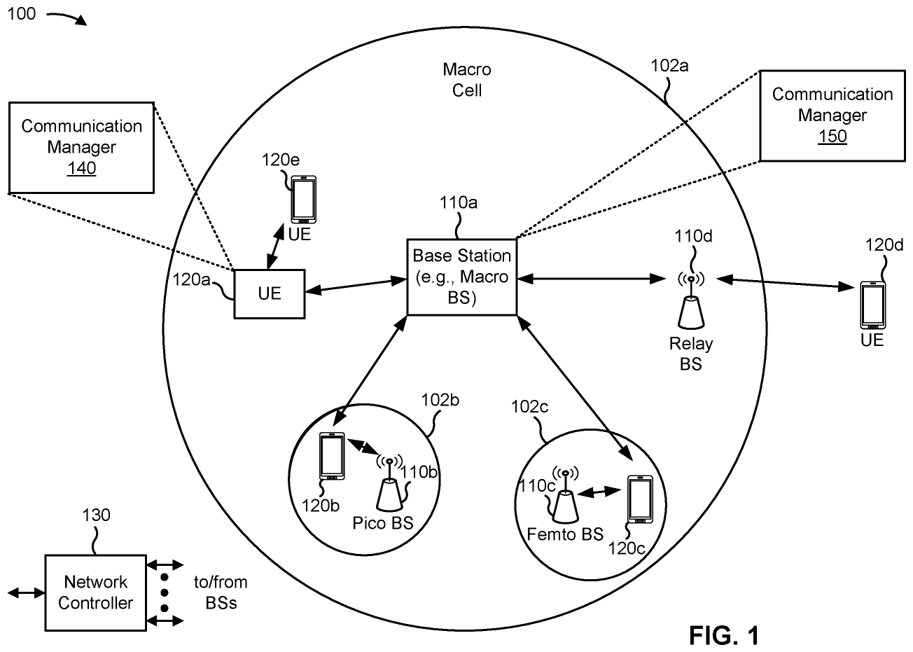

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of a first resource pool associated with a first component carrier and a second resource pool associated with a second component carrier. The communication manager 140 may also receive an indication of a resource allocation associated with a sidelink communication, wherein the resource allocation is based at least in part on at least one of the first resource pool or the second resource pool. The communication manager 140 may also perform the sidelink communication in accordance with the resource allocation. Additionally, or alternatively, the communication manager 140 may perform one or more other operations described herein.

In some aspects, the base station 110 may include a communication manager 150. As described in more detail elsewhere herein, the communication manager 150 may transmit, to a UE, a configuration of a first resource pool associated with a first component carrier and a second resource pool associated with a second component carrier. The communication manager 150 may also transmit, to the UE, an indication of a resource allocation associated with a sidelink communication, wherein the resource allocation is based at least in part on at least one of the first resource pool or the second resource pool. Additionally, or alternatively, the communication manager 150 may perform one or more other operations described herein.

As indicated above, FIG. 1 is provided as an example. Other examples may differ from what is described with regard to FIG. 1.

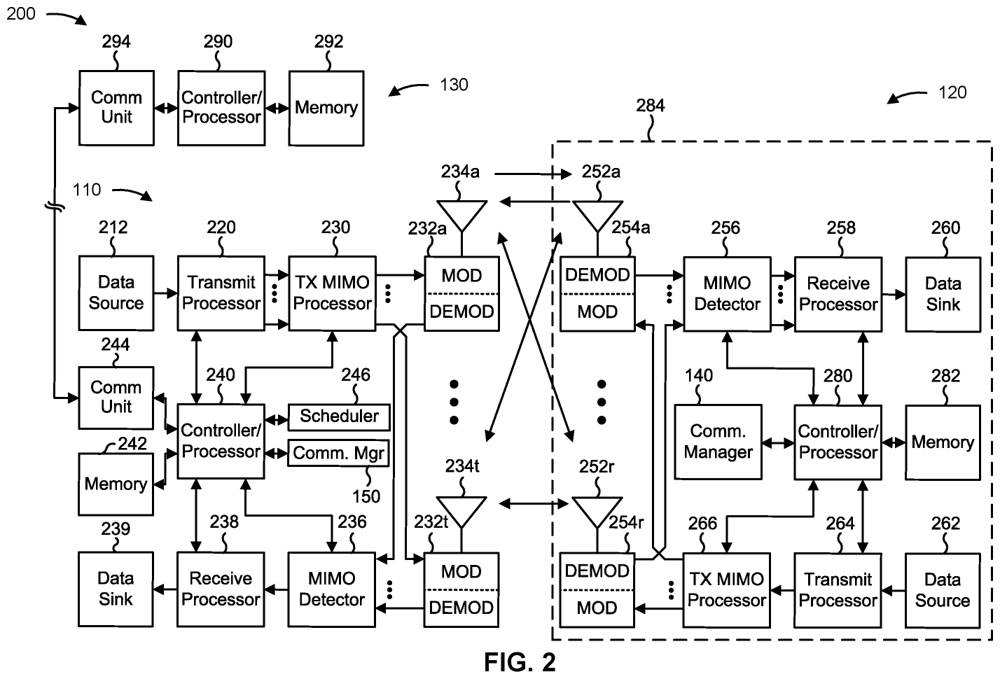

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

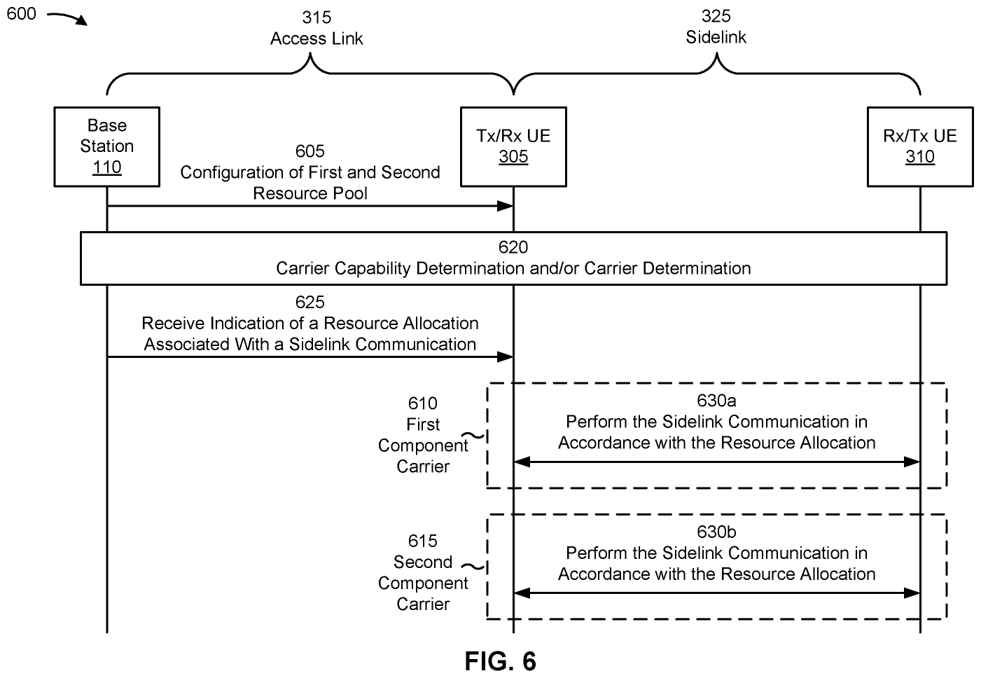

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

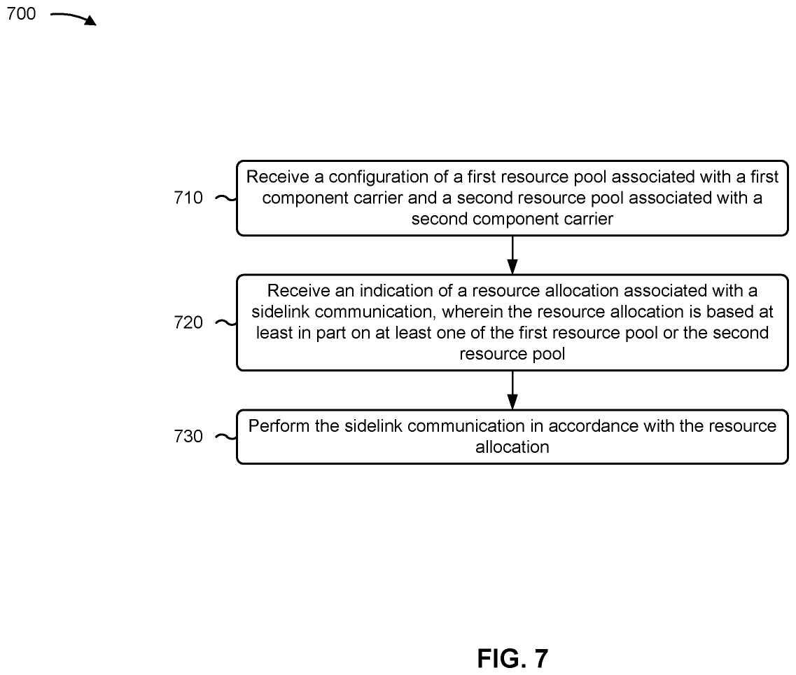

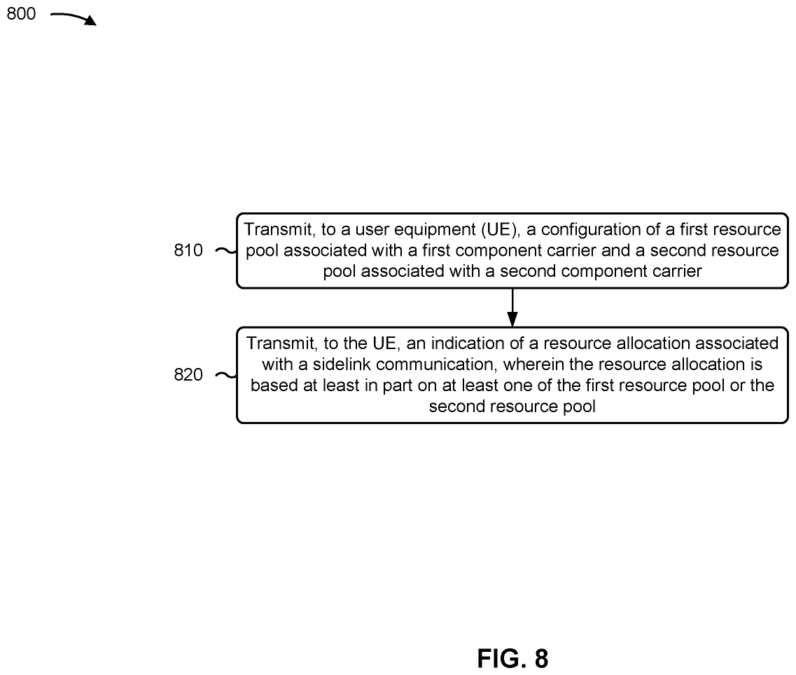

The controller/processor 240 of the base station 110, the controller/processor 280 of the UE 120, and/or any other component(s) of FIG. 2 may perform one or more techniques associated with multi-carrier scheduling for sidelink communications, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving a configuration of a first resource pool associated with a first component carrier and a second resource pool associated with a second component carrier; means for receiving an indication of a resource allocation associated with a sidelink communication, wherein the resource allocation is based at least in part on at least one of the first resource pool or the second resource pool; and/or means for performing the sidelink communication in accordance with the resource allocation. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE (e.g., the UE 120), a configuration of a first resource pool associated with a first component carrier and a second resource pool associated with a second component carrier; and/or means for transmitting, to the UE, an indication of a resource allocation associated with a sidelink communication, wherein the resource allocation is based at least in part on at least one of the first resource pool or the second resource pool. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

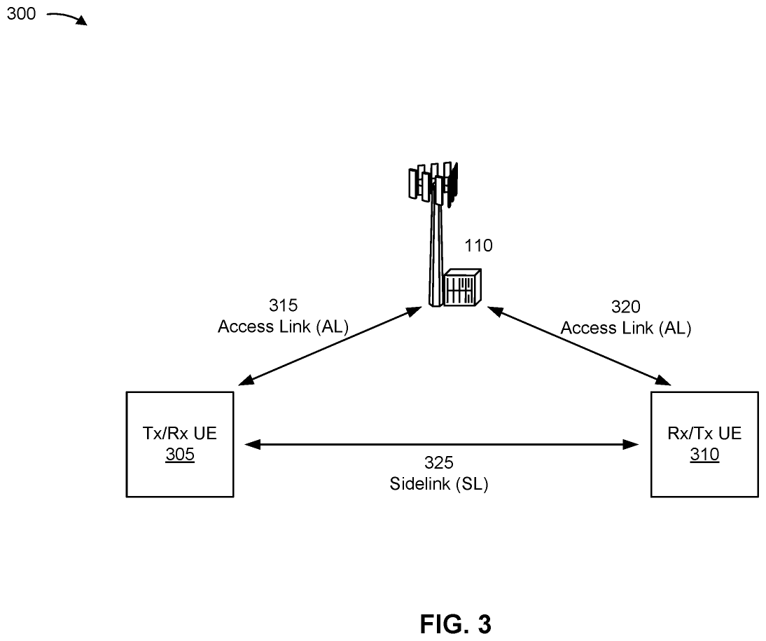

FIG. 3 is a diagram illustrating an example 300 of sidelink communications and access link communications, in accordance with the present disclosure.

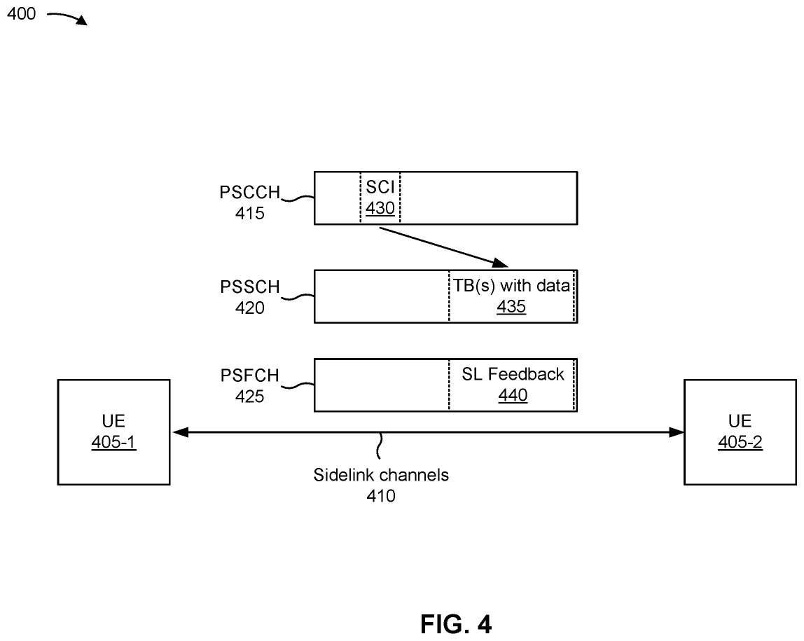

As shown in FIG. 3, a transmitter (Tx)/receiver (Rx) UE 305 and an Rx/Tx UE 310 may communicate with one another via a sidelink. In some sidelink modes, a base station 110 may communicate with the Tx/Rx UE 305 via a first access link 315. Additionally, or alternatively, in some sidelink modes, the base station 110 may communicate with the Rx/Tx UE 310 via a second access link 320. The Tx/Rx UE 305 and/or the Rx/Tx UE 310 may correspond to one or more UEs described elsewhere herein, such as the UE 120 of FIG. 1. Thus, a direct link between UEs 120 (e.g., via a PC5 interface) may be referred to as a sidelink 325, and a direct link between a base station 110 and a UE 120 (e.g., via a Uu interface) may be referred to as an access link 315, 320. Sidelink communications may be transmitted via the sidelink 325, and access link communications may be transmitted via the access link 315, 320. An access link communication may be either a downlink communication (from a base station 110 to a UE 120) or an uplink communication (from a UE 120 to a base station 110). Aspects of the sidelink 325 are described in more detail below in connection with FIG. 4.

As indicated above, FIG. 3 is provided as an example. Other examples may differ from what is described with respect to FIG. 3.

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. In some aspects, the UEs 405 (e.g., the first UE 405-1 and/or the second UE 405-2) may correspond to one or more other UEs described elsewhere herein, such as UE 120. Additionally, or alternatively, the first UE 405-1 may correspond to one of the Tx/Rx UE 305 or the Rx/Tx UE 310, and the second UE 405-2 may correspond to the other of the Tx/Rx UE 305 or the Rx/Tx UE 310. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 via an access link or an access channel. The PSSCH 420 may be used to communicate data, similar to a physical downlink shared channel (PDSCH) and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a base station 110. For example, the UE 405 may receive a grant (e.g., in downlink control information (DCI) or in a radio resource control (RRC) message, such as for configured grants) from the base station 110 for sidelink channel access and/or scheduling. In some aspects, a UE 405 may operate using a transmission mode (e.g., Mode 2) where resource selection and/or scheduling is performed by the UE 405 (e.g., rather than a base station 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy rate (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

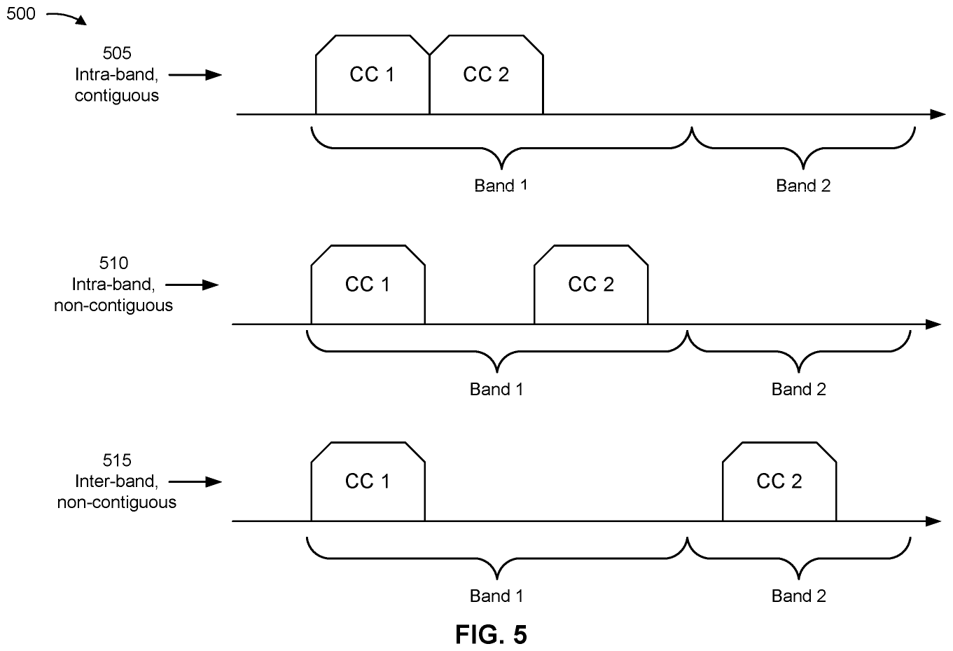

FIG. 5 is a diagram illustrating examples 500 of carrier aggregation, in accordance with the present disclosure.

In some aspects, it may be beneficial for UEs communicating using the sidelink 325 (e.g., one or more of UEs 120, 305, 310, 405-, 405-2, described above) to communicate using multiple carriers, such as by employing carrier aggregation or similar techniques. Carrier aggregation enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A base station 110 may configure carrier aggregation for a UE 120, such as in a radio resource control (RRC) message, downlink control information (DCI), and/or another signaling message.

As shown by reference number 505, in some aspects, carrier aggregation may be configured in an intra-band contiguous mode where the aggregated carriers are contiguous to one another and are in the same band. As shown by reference number 510, in some aspects, carrier aggregation may be configured in an intra-band non-contiguous mode where the aggregated carriers are non-contiguous to one another and are in the same band. As shown by reference number 515, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling. In some aspects, rather than combining the two component carriers into a single channel, a transmission may be selectively scheduled on one or both of the component carriers based at least in part on UE 120 and/or base station 110 capability, network traffic, or the like.

It may be beneficial for UEs (e.g., UEs 120, 305, 310, 405-1, 405-2) to utilize carrier aggregation and/or multiple-carrier techniques for sidelink communication to support advanced applications requiring high throughput, such as coordinate driving, sensor sharing with V2V and V2I, links to achieve autonomous driving, and the like. However, carrier aggregation and/or multiple-carrier techniques pose challenges for Mode 1 sidelink communication resource scheduling (e.g., sidelink resource scheduling performed by a base station 110). This is because the carrier capability of a receiving UE may be unknown to the base station (e.g., the base station 110 may not know which UEs will be receiving a sidelink communication, and thus the base station 110 may not know whether the receiving UEs are capable of communicating in certain carriers). For example, if the base station 110 in FIG. 3 does not establish the access link 320 connection with the Rx/Tx UE 310 and/or if the base station 110 is unaware that the Rx/Tx UE 310 will be the UE receiving a sidelink communication from the Tx/Rx UE 305, the base station 110 will not know which carriers the receiving UE is capable of using. Thus, when scheduling resources for use by the Tx/Rx UE 305 and the Rx/Tx UE 310 to communicate in the sidelink 325, the base station 110 may be limited to scheduling resources only in a legacy carrier (e.g., a carrier that is known by the base station 110 as being available for use by most sidelink-capable UEs). As a result, frequency bands for communication in the sidelink 325 may be limited to legacy carriers or the like, resulting in congested channels, reduced throughput, increased latency, and otherwise unreliable communication channels for advanced sidelink applications.

Some techniques and apparatuses described herein enable multi-carrier resource scheduling in resource allocation Mode 1 for sidelink communications. In some aspects, a base station (e.g., the base station 110) may allocate sidelink communication resources in multiple component carriers, and a transmitter UE (e.g., the Tx/Rx UE 305) may transmit duplicated communications in the multiple component carriers so that a receiver UE (e.g., the Rx/Tx UE 310) may receive the communication regardless of a carrier capability of the receiving UE. Additionally, or alternatively, the base station and/or the transmitter UE may determine a carrier capability of the receiver UE prior to the base station scheduling resources for the sidelink communication, and thus the base station may schedule resources for the sidelink communication (e.g., determine one or more component carriers for use during the sidelink communication) based at least in part on the carrier capability of the receiver UE. In some aspects, the base station and/or the transmitter UE may determine one or more component carriers for use during the sidelink communication based at least in part on an application type of the communication being transmitted, a cast type for the communication being transmitted, and/or a congestion of the various component carriers. In some aspects, the transmitter UE may determine a suitable carrier or carriers for use for the sidelink communication, based at least in part on factors such as those described above, and indicate the determined carrier or carriers to the base station via a sidelink request or the like. In some other aspects, the transmitter UE may transmit an identifier associated with the receiver UE to the base station, and the base station may determine a carrier capability of the receiver UE based at least in part on the identifier. As a result, a base station may schedule resources in various component carriers, enabling UEs communicating in the sidelink to employ carrier aggregation and/or multi-carrier sidelink communication techniques, resulting in a broader spectrum usage, increased throughput, decreased latency, and more reliable communication channels for advanced sidelink applications.

As indicated above, FIG. 5 is provided as an example. Other examples may differ from what is described with regard to FIG. 5.

FIG. 6 is a diagram illustrating an example 600 associated with multi-carrier scheduling for sidelink communications, in accordance with the present disclosure. As shown in FIG. 6, a first UE 120 (e.g., the Tx/Rx UE 305 in the depicted example, but which, in some other aspects, may correspond to any of the other UEs described herein, such as one of the first UE 405-1 or the second UE 405-2) and a second UE 120 (e.g., the Rx/Tx UE 310 in the depicted example, but which, in some other aspects, may correspond to any of the other UEs described herein, such as one of the first UE 405-1 or the second UE 405-2) may communicate with one another via the sidelink 325. Moreover, one or both of the UEs 305, 310 may communicate with a base station 110 via a respective access link 315, 320. For example, for purposes of the description, the Tx/Rx UE 305 is shown in communication with the base station 110 via the access link 315, but, in some other aspects, the Rx/Tx UE 310 may instead be in communication with the base station 110 via the access link 320, and/or both the Tx/Rx UE 305 and the Rx/Tx UE 310 may be in communication with the base station 110 via the access links 315 and 320, respectively. Moreover, in some aspects, one or both of the UEs 305, 310 may be in communication with multiple other UEs, such as when one of the UEs 305, 310 is operating in a groupcast or a broadcast mode, as described in more detail below.

As shown by reference number 605, the Tx/Rx UE 305 may receive, from the base station 110, a configuration of a first resource pool associated with a first component carrier 610 and a second resource pool associated with a second component carrier 615. In some aspects, the first component carrier 610 may be a legacy carrier (e.g., a component carrier capable of use by most sidelink-enabled UEs, even those not associated with a relatively new release of a wireless communication standard or the like), while the second component carrier 615 may be a non-legacy carrier (e.g., a component carrier capable of use by fewer UEs than are capable of communicating using the legacy carrier, such as by UEs associated with the relatively new release of the wireless communication standard or the like). At a high level, a resource pool is a set of resources available for sidelink communication. More particularly, a resource pool is a set of resources configured for (e.g., assigned for) sidelink communication. A resource pool may be configured via semi-static (e.g., radio resource control (RRC)) signaling. A resource pool may be configured to include particular time resources (e.g., slots) and a particular set of contiguous frequency resources (e.g., resource blocks). A resource pool (e.g., the arrangement of time resources included in the resource pool) may periodically repeat. Accordingly, the configuration indicated by reference number 605 (which, in some aspects, may be received via RRC signaling) may include a configuration of a first set of time and/or frequency resources available for performing sidelink communication in the first component carrier 610 and a configuration of a second set of time and/or frequency resources available for performing sidelink communication in the second component carrier 615. In some aspects, the first component carrier 610 and the second component carrier 615 may be employed for purposes of carrier aggregation and/or multi-carrier resource scheduling as described above in connection with FIG. 5, and thus the first component carrier 610 and/or the second component carrier 615 may each correspond to one of the component carriers described above in connection with FIG. 5.

As shown by reference number 620, one or more of the base station 110, the Tx/Rx UE 305, and/or the Rx/Tx UE 310 may signal, to one another, information used to determine a carrier capability of one or more of the UEs 305, 310 and/or used to determine a component carrier to be used for sidelink communication. For example, in the signaling indicated by reference number 620, the Tx/Rx UE 305 may receive an indication from the Rx/Tx UE 310 indicating a carrier capability of the Rx/Tx UE 310 (e.g., whether the Rx/Tx UE 310 is capable of receiving a sidelink communication in the first component carrier 610 and/or the second component carrier 615, and/or whether the Rx/Tx UE 310 is capable of receiving sidelink communications using multi-carrier techniques and/or carrier aggregation techniques), and the Tx/Rx UE 305 may thus determine one or more carriers (e.g., one or both of the first component carrier 610 or the second component carrier 615) to be used for sidelink communication. Additionally, or alternatively, in the signaling indicated by reference number 620, the base station 110 may receive an indication indicating a carrier capability of the Rx/Tx UE 310 (which, in some aspects, may be transmitted to the Tx/Rx UE 305 by the Rx/Tx UE 310, and then may be transmitted to the base station 110 by the Tx/Rx UE 305), and the base station 110 may thus determine one or more carriers (e.g., one or both of the first component carrier 610 or the second component carrier 615) to be used for sidelink communication. Aspects of the carrier capability determination and/or the carrier determination are described in more detail below.

As shown by reference number 625, in some aspects (e.g., when the Tx/Rx UE 305 is operating using Mode 1, where resource selection and/or scheduling is performed by the base station 110), the Tx/Rx UE 305 may receive, from the base station 110, an indication of a resource allocation associated with a sidelink communication. In some aspects, the indication of the resource allocation associated with the sidelink communication may indicate that resources in the first resource pool and/or resources in the second resource pool are allocated for performing sidelink communication. For example, when the indication of the resource allocation associated with the sidelink communication indicates that resources in the first resource pool are allocated for sidelink communication, the Tx/Rx UE 305 and the Rx/Tx UE 310 may perform sidelink communication using the resources in the first resource pool (e.g., within the first component carrier 610), as shown by reference number 630a. Additionally, or alternatively, when the indication of the resource allocation associated with the sidelink communication indicates that resources in the second resource pool are allocated for sidelink communication, the Tx/Rx UE 305 and the Rx/Tx UE 310 may perform sidelink communication using the resources in the second resource pool (e.g., within the second component carrier 615), as shown by reference number 630b.

In some aspects, the indication of the resource allocation associated with the sidelink communication as shown by reference number 625 indicates that resources in both the first resource pool and the second resource pool are allocated for sidelink communication. Put another way, the indication may indicate that the UEs 305, 310 may perform sidelink communication in both the first component carrier 610 and the second component carrier 615. In such aspects, the Tx/Rx UE 305 may transmit a duplicated communication using both the first component carrier 610 and the second component carrier 615 (e.g., the communication indicated by reference number 630a is a duplicate of the communication indicated by reference number 630b). For example, if the Tx/Rx UE 305 and Rx/Tx UE 310 are operating in a unicast mode (e.g., the Tx/Rx UE 305 and Rx/Tx UE 310 are communicating on the sidelink 325 only with each other and not with other UEs), but a carrier capability of the Rx/Tx UE 310 is unknown to the base station 110 and/or the Tx/Rx UE 305, the Tx/Rx UE 305 may transmit both the communication indicated at reference number 630a and the communication indicated at reference number 630b to ensure the Rx/Tx UE 310 receives the communication notwithstanding the carrier capability of the Rx/Tx UE 310 (e.g., so that the Rx/Tx UE 310 receives the communication, notwithstanding an ability of the Rx/Tx UE 310 to receive communications in the non-legacy carrier). Additionally, or alternatively, if Tx/Rx UE 305 is operating in a connection-less groupcast mode or a broadcast mode, the Tx/Rx UE 305 may be communicating with a group of UEs without knowing an identity and/or a carrier capability of each UE that may ultimately receive the sidelink communication. Thus, the indication of the resource allocation associated with the sidelink communication may indicate that multiple component carriers (e.g., the first component carrier 610 and the second component carrier 615) may be employed to transmit a duplicated communication to ensure the various UEs receive the communication.

In some aspects, rather than using both resource pools for transmitting duplicated transmissions as described above, the base station 110 and/or the Tx/Rx UE 305 may selectively determine whether to use the first component carrier 610 (and thus the resources associated with the first resource pool) or the second component carrier 615 (and thus the resources associated with the first resource pool) for sidelink communication. For example, in some aspects, the base station 110 and/or the Tx/Rx UE 305 may determine which component carrier may be used based at least in part on a carrier capability of the Rx/Tx UE 310. In such aspects, in the signaling indicated by reference number 620, the base station 110 and/or the Tx/Rx UE 305 may receive, from the Rx/Tx UE 310, an indication of the carrier capability of the Rx/Tx UE 310. For example, in embodiments in which the Tx/Rx UE 305 is operating in a unicast mode with the Rx/Tx UE 310 or is operating in a connection-based groupcast mode with the Rx/Tx UE 310, the Tx/Rx UE 305 and/or the base station 110 may request that the Rx/Tx UE 310 provide carrier capability information, and the Rx/Tx UE 310 may thus transmit an indication of the carrier capability of the Rx/Tx UE 310 (e.g., whether the Rx/Tx UE 310 is capable of carrier aggregation, whether the Rx/Tx UE 310 is capable of receiving communications in the first component carrier 610 and/or the second component carrier 615, or the like) in advance of receiving the communications indicated by reference numbers 630a and 630b. The base station 110 and/or the Tx/Rx UE 305 may then determine which component carriers may be used to schedule a communication based at least in part on the carrier capability of the Rx/Tx UE 310, as indicated by reference number 620.

Additionally, or alternatively, the base station 110 and/or the Tx/Rx UE 305 may determine which component carrier may be used based at least in part on a message and/or an application type to be communicated using the sidelink 325. For example, in some aspects, it may be beneficial to transmit an initial RRC message or similar message establishing a connection between the Tx/Rx UE 305 and the Rx/Tx UE 310 (sometimes referred to as a PC5 RRC message) using at least the legacy carrier (e.g., the first component carrier 610) so that the message establishing the connection is received notwithstanding a carrier capability of the reception Rx/Tx UE 310. More particularly, in aspects in which the first component carrier 610 is the legacy carrier, the PC5 RRC message may be sent using at least the first resources. Once a connection between the Tx/Rx UE 305 and the Rx/Tx UE 310 is established, however, a data transmission or similar message may be sent using other component carriers (e.g., the second component carrier 615) if it is determined that the Rx/Tx UE 310 is capable of receiving messages in other carriers, as described above.

Moreover, in some aspects, an identifier associated with a transmission from the Rx/Tx UE 310 may implicitly indicate whether the Rx/Tx UE 310 is capable of receiving communications in one or more component carriers. More particularly, an application identifier associated with a transmission received by the Tx/Rx UE 305 from the Rx/Tx UE 310 may indicate that the Rx/Tx UE 310 is capable of handling advanced applications (e.g., may indicate that the Rx/Tx UE 310 is associated with a relatively new release of a wireless standard), which may implicitly indicate to the base station 110 and/or the Tx/Rx UE 305 that the Rx/Tx UE 310 is capable of communicating using carrier aggregation and/or multi-carrier techniques and/or that no legacy duplication is necessary (e.g., the identifier may indicate to the base station 110 and/or the Tx/Rx UE 305 that it is unnecessary to duplicate messages in both the first component carrier 610 and the second component carrier 615 because the Rx/Tx UE 310 is capable of receiving transmissions in either carrier, and thus sidelink communications may be scheduled in either carrier).

Additionally, or alternatively, the base station 110 and/or the Tx/Rx UE 305 may determine which component carrier may be used based at least in part on a cast mode to be employed (e.g., whether the sidelink communication is one of a unicast communication, a groupcast communication, or a broadcast communication). For example, for unicast communications and/or connection-based groupcast communications, the base station 110 and/or the Tx/Rx UE 305 may be capable of requesting carrier capability information from the Rx/Tx UE 310. Thus, in some aspects, for these types of communications, non-legacy carriers (e.g., the second component carrier 615) may be used for transmissions when it is determined that Rx/Tx UE 310 supports sidelink communication in the non-legacy carrier. However, for connectionless-based groupcast communications and/or broadcast communications, the base station 110 and/or the Tx/Rx UE 305 may not know the identities of the UEs receiving the communication and/or may not be able to request carrier capability information from the receiving UEs. Thus, in such aspects, the transmissions may be transmitted using at least the legacy carrier (e.g., the first component carrier 610) to ensure that all relevant UEs receive the transmissions.

Additionally, or alternatively, the base station 110 and/or the Tx/Rx UE 305 may determine which component carrier may be used based at least in part on one or more channel congestion measurements or similar types of measurements, such as a CBR measurement and/or a channel occupancy ratio (CR). For example, one or more of the Tx/Rx UE 305, the Rx/Tx UE 310, or other UEs (such as another UE receiving a groupcast communication or a broadcast communication) may measure a CBR and/or a CR and transmit the measurements to another UE (e.g., the Tx/Rx UE 305) and/or the base station 110. The base station 110 and/or the other UE (e.g., the Tx/Rx UE 305) may then allocate more resources to a less-busy component carrier. For example, if the CBR and/or CR measurements indicate that the second component carrier 615 has less traffic than the first component carrier 610, the base station 110 and/or the Tx/Rx UE 305 may schedule more resources on the second component carrier 615 than on the first component carrier 610 (e.g., the Tx/Rx UE 305 may schedule more resources associated with the second resource pool than associated with the first resource pool), assuming that the Rx/Tx UE 310 is capable of receiving transmissions in the second component carrier 615. In some aspects, the Tx/Rx UE 305 may determine one or more carriers to be used based at least in part on CBR and/or CR measurements performed by the Tx/Rx UE 305 and/or received from the Rx/Tx UE 310. In such aspects, when sending the carrier determination to the base station 110 via a sidelink request or the like, the Tx/Rx UE 305 may not include an indication of the CBR measurements, CR measurements, or other channel congestion measurements (e.g., the channel congestion determination may be transparent to the base station 110).

In aspects in which the Tx/Rx UE 305 determines which component carrier or carriers to use for sidelink communication, the signaling indicated by reference number 620 may include the Tx/Rx UE 305 transmitting, to the base station 110, an indication of the determination of whether to use the first component carrier or the second component carrier for the sidelink communication. For example, the Tx/Rx UE 305 may transmit, to the base station 110, a sidelink request (e.g., a request including a scheduling request and/or a buffer status report) that indicates whether certain component carriers may be scheduled for sidelink communication. That is, the sidelink request may include an indication of whether the first component carrier 610 and/or the second component carrier 615 are permitted to be used for the sidelink communication.

In some aspects, the indication of whether the first component carrier 610 and the second component carrier 615 are permitted to be used for the sidelink communication may be based at least in part on a carrier used by the Tx/Rx UE 305 to transmit the sidelink request to the base station 110. For example, the Tx/Rx UE 305 may indicate to the base station 110 that resources may be scheduled on the second component carrier 615 by transmitting the sidelink request via the second component carrier 615. Additionally, or alternatively, the sidelink request may include an explicit indication of which component carriers are permitted to be used for the sidelink communication. The explicit indication of which component carriers are permitted to be used for the sidelink communication may be indicated using a bitmap, a carrier index indication or code point, or similar indication. Additionally, or alternatively, the sidelink request may indicate which component carriers are permitted to be used for the sidelink communication via a logical channel identifier associated with the buffer status report.

Once the base station 110 receives the indication of which component carriers are permitted to be used for the sidelink communication via one of the methods described above or otherwise, the base station 110 may schedule resources in the resource pools associated with the indicated carrier or carriers, and then signal the indication of the resource allocation, as described above in connection with reference number 625. In some aspects, the base station 110 may signal the indication of the resource allocation using a downlink control information (DCI) message, and more particularly by using a specific DCI format corresponding to the resource allocation. In this regard, a first DCI format used to indicate a resource allocation in a legacy carrier (e.g., the first component carrier 610) may be different than a second DCI format used to indicate a resource allocation in a non-legacy carrier (e.g., the second component carrier 615).

In aspects in which the base station 110 determines which component carriers to use for sidelink communication, the signaling indicated by reference number 620 may include the Tx/Rx UE 305 and/or the Rx/Tx UE 310 transmitting, to the base station 110, an indication of the carrier capability of the Rx/Tx UE 310 and/or an indication of an identifier associated with the Rx/Tx UE 310. More particularly, when transmitting the sidelink request to the base station 110, the Tx/Rx UE 305 may indicate an identifier associated with the Rx/Tx UE 310, such as a radio network temporary identifier (RNTI), a PC5 identifier (e.g., a source Layer 2 (L2) identifier), or similar identifier. Moreover, the base station 110 may be aware of the corresponding identifier associated with the Rx/Tx UE 310 and/or a carrier capability of the Rx/Tx UE 310 based at least in part on the corresponding identifier, and thus the base station 110 may determine a carrier or carriers for sidelink communication based at least in part on the identifier. For example, the Rx/Tx UE 310 may transmit, to the Tx/Rx UE 305, the RNTI associated with the Rx/Tx UE 310, the PC5 identifier (e.g., the source L2 identifier) associated with the Rx/Tx UE 310, and/or a similar identifier, and the Tx/Rx UE 305 may indicate in the sidelink request transmitted to the base station 110 the corresponding identifier of the Rx/Tx UE 310. The base station 110 may use the RNTI, PC5 identifier, or another identifier to reference an index or the like indicating a carrier capability of the Rx/Tx UE 310 associated with the corresponding identifier, and the base station 110 may thus schedule the sidelink communication in one or more carriers capable of use by the Rx/Tx UE 310. In some aspects, the base station may signal the indication of the scheduled resource (as shown by reference number 625) using a DCI message, as described.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120, Tx/Rx 305, Rx/Tx UE 310, UE 405-1, or UE 405-2) performs operations associated with multi-carrier scheduling for sidelink communications.

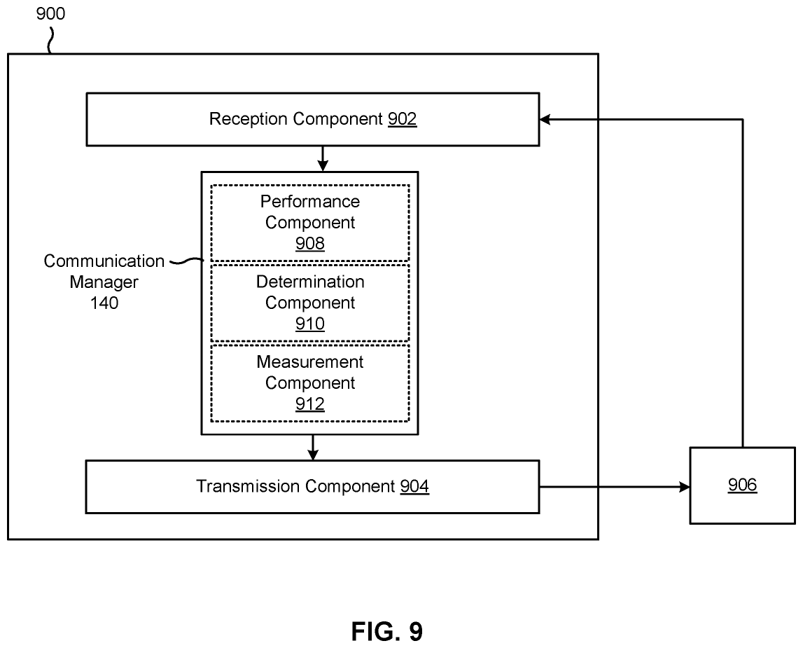

As shown in FIG. 7, in some aspects, process 700 may include receiving a configuration of a first resource pool associated with a first component carrier and a second resource pool associated with a second component carrier (block 710). For example, the UE (e.g., using communication manager 140 and/or reception component 902, depicted in FIG. 9) may receive a configuration of a first resource pool associated with a first component carrier and a second resource pool associated with a second component carrier, as described above.

As further shown in FIG. 7, in some aspects, process 700 may include receiving an indication of a resource allocation associated with a sidelink communication, wherein the resource allocation is based at least in part on at least one of the first resource pool or the second resource pool (block 720). For example, the UE (e.g., using communication manager 140 and/or reception component 902, depicted in FIG. 9) may receive an indication of a resource allocation associated with a sidelink communication, wherein the resource allocation is based at least in part on at least one of the first resource pool or the second resource pool, as described above.

As further shown in FIG. 7, in some aspects, process 700 may include performing the sidelink communication in accordance with the resource allocation (block 730). For example, the UE (e.g., using communication manager 140 and/or performance component 908, depicted in FIG. 9) may perform the sidelink communication in accordance with the resource allocation, as described above.

Process 700 may include additional aspects, such as any single aspect or any combination of aspects described below and/or in connection with one or more other processes described elsewhere herein.

In a first aspect, the resource allocation is based at least in part on both the first resource pool and the second resource pool, and performing the sidelink communication includes transmitting a duplicated communication using both the first component carrier and the second component carrier.

In a second aspect, alone or in combination with the first aspect, the sidelink communication is at least one of a groupcast communication, a broadcast communication, or a unicast communication with another UE.

In a third aspect, alone or in combination with one or more of the first and second aspects, the sidelink communication is the unicast communication with the other UE, and the other UE is associated with an unknown carrier capability.

In a fourth aspect, alone or in combination with one or more of the first through third aspects, the resource allocation is based at least in part on a determination of whether to use the first component carrier or the second component carrier for the sidelink communication.

In a fifth aspect, alone or in combination with one or more of the first through fourth aspects, the determination is based at least in part a carrier capability of one or more other UEs receiving the sidelink communication.

In a sixth aspect, alone or in combination with one or more of the first through fifth aspects, process 700 includes receiving an indication of the carrier capability of the one or more other UEs from the one or more other UEs.

In a seventh aspect, alone or in combination with one or more of the first through sixth aspects, process 700 includes determining the carrier capability of the one or more other UEs based at least in part on an identifier associated with a transmission received from the one or more other UEs.

In an eighth aspect, alone or in combination with one or more of the first through seventh aspects, the determination is based at least in part on a type of an application being transmitted using the sidelink communication.

In a ninth aspect, alone or in combination with one or more of the first through eighth aspects, the determination is based at least in part on whether a message being transmitted using the sidelink communication is a unicast communication, a groupcast communication, or a broadcast communication.

In a tenth aspect, alone or in combination with one or more of the first through ninth aspects, the determination is based at least in part on at least one channel congestion parameter.

In an eleventh aspect, alone or in combination with one or more of the first through tenth aspects, the at least one channel congestion parameter includes at least one CBR.

In a twelfth aspect, alone or in combination with one or more of the first through eleventh aspects, the at least one CBR includes a first CBR associated with the first component carrier and a second CBR associated with the second component carrier.

In a thirteenth aspect, alone or in combination with one or more of the first through twelfth aspects, process 700 includes measuring a first channel congestion parameter associated with the first component carrier, and measuring a second channel congestion parameter associated with the second component carrier, wherein the determination is based at least in part on the first channel congestion parameter and the second channel congestion parameter.

In a fourteenth aspect, alone or in combination with one or more of the first through thirteenth aspects, process 700 includes transmitting, to a network entity, the first channel congestion parameter and the second channel congestion parameter, wherein the determination is performed by the network entity based at least in part on the first channel congestion parameter and the second channel congestion parameter.

In a fifteenth aspect, alone or in combination with one or more of the first through fourteenth aspects, process 700 includes transmitting, to a network entity, an indication of the determination of whether to use the first component carrier or the second component carrier for the sidelink communication, wherein the determination is performed by the UE based at least in part on the first channel congestion parameter and the second channel congestion parameter, and wherein the indication of the determination does not include the first channel congestion parameter or the second channel congestion parameter.

In a sixteenth aspect, alone or in combination with one or more of the first through fifteenth aspects, process 700 includes transmitting, to a network entity, a scheduling request associated with the sidelink communication, wherein the scheduling request includes an indication of whether the first component carrier and the second component carrier are permitted to be used for the sidelink communication.

In a seventeenth aspect, alone or in combination with one or more of the first through sixteenth aspects, the indication is based at least in part on at least one of a carrier used to transmit the scheduling request, a carrier index indication provided with the scheduling request, a carrier bitmap provided with the scheduling request, or a logical channel identifier included in a buffer status report associated with the scheduling request.

In an eighteenth aspect, alone or in combination with one or more of the first through seventeenth aspects, process 700 includes transmitting, to a network entity, a scheduling request associated with the sidelink communication, wherein the scheduling request includes an identifier associated with another UE receiving the sidelink communication, wherein the resource allocation is based at least in part on the identifier associated with the other UE.

In a nineteenth aspect, alone or in combination with one or more of the first through eighteenth aspects, the identifier associated with the other UE is one of an RNTI or a sidelink interface identifier.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., base station 110) performs operations associated with multi-carrier scheduling for sidelink communications.

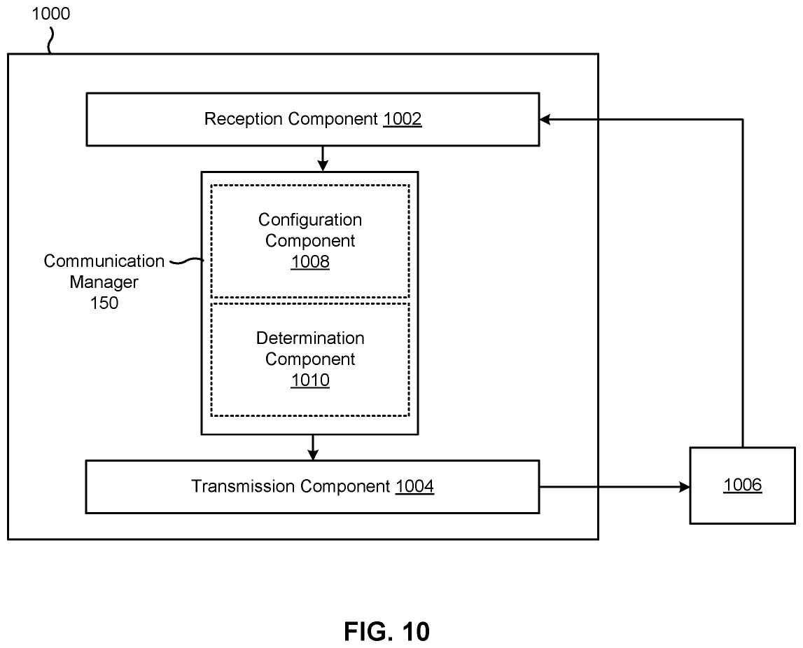

As shown in FIG. 8, in some aspects, process 800 may include transmitting, to a UE (e.g., UE 120, Tx/Rx 305, Rx/Tx UE 310, UE 405-1, or UE 405-2), a configuration of a first resource pool associated with a first component carrier and a second resource pool associated with a second component carrier (block 810). For example, the network entity (e.g., using communication manager 150 and/or transmission component 1004, depicted in FIG. 10) may transmit, to a UE, a configuration of a first resource pool associated with a first component carrier and a second resource pool associated with a second component carrier, as described above.

As further shown in FIG. 8, in some aspects, process 800 may include transmitting, to the UE, an indication of a resource allocation associated with a sidelink communication, wherein the resource allocation is based at least in part on at least one of the first resource pool or the second resource pool (block 820). For example, the network entity (e.g., using communication manager 150 and/or transmission component 1004, depicted in FIG. 10) may transmit, to the UE, an indication of a resource allocation associated with a sidelink communication, wherein the resource allocation is based at least in part on at least one of the first resource pool or the second resource pool, as described above.

Process 800 may include additional aspects, such as any single aspect or any combination of aspects described below and/or in connection with one or more other processes described elsewhere herein.

In a first aspect, the resource allocation is based at least in part on both the first resource pool and the second resource pool, and the sidelink communication includes a duplicated communication transmitted using both the first component carrier and the second component carrier.

In a second aspect, alone or in combination with the first aspect, the sidelink communication is at least one of a groupcast communication, a broadcast communication, or a unicast communication with another UE.

In a third aspect, alone or in combination with one or more of the first and second aspects, the sidelink communication is the unicast communication with the other UE, and the other UE is associated with an unknown carrier capability.

In a fourth aspect, alone or in combination with one or more of the first through third aspects, the resource allocation is based at least in part on a determination of whether to use the first component carrier or the second component carrier for the sidelink communication.

In a fifth aspect, alone or in combination with one or more of the first through fourth aspects, the determination is based at least in part a carrier capability of one or more other UEs receiving the sidelink communication.

In a sixth aspect, alone or in combination with one or more of the first through fifth aspects, process 800 includes receiving an indication of the carrier capability of the one or more other UEs from the one or more other UEs.

In a seventh aspect, alone or in combination with one or more of the first through sixth aspects, process 800 includes determining the carrier capability of the one or more other UEs based at least in part on an identifier associated with a transmission received from the one or more other UEs.

In an eighth aspect, alone or in combination with one or more of the first through seventh aspects, the determination is based at least in part on a type of an application being transmitted using the sidelink communication.

In a ninth aspect, alone or in combination with one or more of the first through eighth aspects, the determination is based at least in part on whether a message being transmitted using the sidelink communication is a unicast communication, a groupcast communication, or a broadcast communication.

In a tenth aspect, alone or in combination with one or more of the first through ninth aspects, the determination is based at least in part on at least one channel congestion parameter.

In an eleventh aspect, alone or in combination with one or more of the first through tenth aspects, the at least one channel congestion parameter includes at least one CBR.

In a twelfth aspect, alone or in combination with one or more of the first through eleventh aspects, the at least one CBR includes a first CBR associated with the first component carrier and a second CBR associated with the second component carrier.

In a thirteenth aspect, alone or in combination with one or more of the first through twelfth aspects, process 800 includes receiving, from the UE, a first channel congestion parameter associated with the first component carrier, and receiving, from the UE, a second channel congestion parameter associated with the second component carrier, wherein the determination is performed by the network entity and is based at least in part on the first channel congestion parameter and the second channel congestion parameter.

In a fourteenth aspect, alone or in combination with one or more of the first through thirteenth aspects, process 800 includes receiving, from the UE, an indication of the determination of whether to use the first component carrier or the second component carrier for the sidelink communication, wherein the determination is performed by the UE based at least in part on the at least one channel congestion parameter, and wherein the indication of the determination does not include the at least one channel congestion parameter.

In a fifteenth aspect, alone or in combination with one or more of the first through fourteenth aspects, process 800 includes receiving, from the UE, a scheduling request associated with the sidelink communication, wherein the scheduling request includes an indication of whether the first component carrier and the second component carrier are permitted to be used for the sidelink communication.

In a sixteenth aspect, alone or in combination with one or more of the first through fifteenth aspects, the indication is based at least in part on at least one of a carrier used to transmit the scheduling request, a carrier index indication provided with the scheduling request, a carrier bitmap provided with the scheduling request, or a logical channel identifier included in a buffer status report associated with the scheduling request.

In a seventeenth aspect, alone or in combination with one or more of the first through sixteenth aspects, process 800 includes receiving, from the UE, a scheduling request associated with the sidelink communication, wherein the scheduling request includes an identifier associated with another UE receiving the sidelink communication, and wherein the resource allocation is based at least in part on the identifier associated with the other UE.

In an eighteenth aspect, alone or in combination with one or more of the first through seventeenth aspects, the identifier associated with the other UE is one of an RNTI or a sidelink interface identifier.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a performance component 908, a determination component 910, or a measurement component 912, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive a configuration of a first resource pool associated with a first component carrier and a second resource pool associated with a second component carrier. The reception component 902 may receive an indication of a resource allocation associated with a sidelink communication, wherein the resource allocation is based at least in part on at least one of the first resource pool or the second resource pool. The performance component 908 may perform the sidelink communication in accordance with the resource allocation.

The reception component 902 may receive an indication of the carrier capability of the one or more other UEs from the one or more other UEs.

The determination component 910 may determine the carrier capability of the one or more other UEs based at least in part on an identifier associated with a transmission received from the one or more other UEs.

The measurement component 912 may measure a first channel congestion parameter associated with the first component carrier.

The measurement component 912 may measure a second channel congestion parameter associated with the second component carrier, wherein a carrier determination is based at least in part on the first channel congestion parameter and the second channel congestion parameter.

The transmission component 904 may transmit, to a network entity, the first channel congestion parameter and the second channel congestion parameter, wherein a carrier determination is performed by the network entity based at least in part on the first channel congestion parameter and the second channel congestion parameter.

The transmission component 904 may transmit, to a network entity, an indication of the determination of whether to use the first component carrier or the second component carrier for the sidelink communication, wherein the determination is performed by the UE based at least in part on the first channel congestion parameter and the second channel congestion parameter, and wherein the indication of the determination does not include the first channel congestion parameter or the second channel congestion parameter.

The transmission component 904 may transmit, to a network entity, a scheduling request associated with the sidelink communication, wherein the scheduling request includes an indication of whether the first component carrier and the second component carrier are permitted to be used for the sidelink communication.

The transmission component 904 may transmit, to a network entity, a scheduling request associated with the sidelink communication, wherein the scheduling request includes an identifier associated with another UE receiving the sidelink communication, wherein the resource allocation is based at least in part on the identifier associated with the other UE.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity (e.g., base station 110), or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include one or more of a configuration component 1008, or a determination component 1010, among other examples.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The transmission component 1004 and/or the configuration component 1008 may transmit, to a UE, a configuration of a first resource pool associated with a first component carrier and a second resource pool associated with a second component carrier. The transmission component 1004 and/or the configuration component 1008 may transmit, to the UE, an indication of a resource allocation associated with a sidelink communication, wherein the resource allocation is based at least in part on at least one of the first resource pool or the second resource pool.

The reception component 1002 may receive an indication of the carrier capability of the one or more other UEs from the one or more other UEs.

The determination component 1010 may determine the carrier capability of the one or more other UEs based at least in part on an identifier associated with a transmission received from the one or more other UEs.

The reception component 1002 may receive, from the UE, a first channel congestion parameter associated with the first component carrier.

The reception component 1002 may receive, from the UE, a second channel congestion parameter associated with the second component carrier, wherein the determination is performed by the network entity and is based at least in part on the first channel congestion parameter and the second channel congestion parameter.

The reception component 1002 may receive, from the UE, an indication of the determination of whether to use the first component carrier or the second component carrier for the sidelink communication, wherein the determination is performed by the UE based at least in part on the at least one channel congestion parameter, and wherein the indication of the determination does not include the at least one channel congestion parameter.

The reception component 1002 may receive, from the UE, a scheduling request associated with the sidelink communication, wherein the scheduling request includes an indication of whether the first component carrier and the second component carrier are permitted to be used for the sidelink communication.

The reception component 1002 may receive, from the UE, a scheduling request associated with the sidelink communication, wherein the scheduling request includes an identifier associated with another UE receiving the sidelink communication, and wherein the resource allocation is based at least in part on the identifier associated with the other UE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving a configuration of a first resource pool associated with a first component carrier and a second resource pool associated with a second component carrier; receiving an indication of a resource allocation associated with a sidelink communication, wherein the resource allocation is based at least in part on at least one of the first resource pool or the second resource pool; and performing the sidelink communication in accordance with the resource allocation.

Aspect 2: The method of Aspect 1, wherein the resource allocation is based at least in part on both the first resource pool and the second resource pool, and wherein performing the sidelink communication includes transmitting a duplicated communication using both the first component carrier and the second component carrier.

Aspect 3: The method of Aspect 2, wherein the sidelink communication is at least one of a groupcast communication, a broadcast communication, or a unicast communication with another UE.

Aspect 4: The method of Aspect 3, wherein the sidelink communication is the unicast communication with the other UE, and wherein the other UE is associated with an unknown carrier capability.

Aspect 5: The method of any of Aspects 1-4, wherein the resource allocation is based at least in part on a determination of whether to use the first component carrier or the second component carrier for the sidelink communication.

Aspect 6: The method of Aspect 5, wherein the determination is based at least in part a carrier capability of one or more other UEs receiving the sidelink communication.

Aspect 7: The method of Aspect 6, further comprising receiving an indication of the carrier capability of the one or more other UEs from the one or more other UEs.

Aspect 8: The method of Aspect 6, further comprising determining the carrier capability of the one or more other UEs based at least in part on an identifier associated with a transmission received from the one or more other UEs.

Aspect 9: The method of Aspect 5, wherein the determination is based at least in part on a type of an application being transmitted using the sidelink communication.

Aspect 10: The method of Aspect 5, wherein the determination is based at least in part on whether a message being transmitted using the sidelink communication is a unicast communication, a groupcast communication, or a broadcast communication.

Aspect 11: The method of Aspect 5, wherein the determination is based at least in part on at least one channel congestion parameter.

Aspect 12: The method of Aspect 11, wherein the at least one channel congestion parameter includes at least one channel busy ratio (CBR).

Aspect 13: The method of Aspect 12, wherein the at least one CBR includes a first CBR associated with the first component carrier and a second CBR associated with the second component carrier.

Aspect 14: The method of Aspect 11, further comprising: measuring a first channel congestion parameter associated with the first component carrier; and measuring a second channel congestion parameter associated with the second component carrier, wherein the determination is based at least in part on the first channel congestion parameter and the second channel congestion parameter.

Aspect 15: The method of Aspect 14, further comprising transmitting, to a network entity, the first channel congestion parameter and the second channel congestion parameter, wherein the determination is performed by the network entity based at least in part on the first channel congestion parameter and the second channel congestion parameter.

Aspect 16: The method of Aspect 14, further comprising transmitting, to a network entity, an indication of the determination of whether to use the first component carrier or the second component carrier for the sidelink communication, wherein the determination is performed by the UE based at least in part on the first channel congestion parameter and the second channel congestion parameter, and wherein the indication of the determination does not include the first channel congestion parameter or the second channel congestion parameter.

Aspect 17: The method of any of Aspects 1-16, further comprising transmitting, to a network entity, a scheduling request associated with the sidelink communication, wherein the scheduling request includes an indication of whether the first component carrier and the second component carrier are permitted to be used for the sidelink communication.

Aspect 18: The method of Aspect 17, wherein the indication is based at least in part on at least one of a carrier used to transmit the scheduling request, a carrier index indication provided with the scheduling request, a carrier bitmap provided with the scheduling request, or a logical channel identifier included in a buffer status report associated with the scheduling request.

Aspect 19: The method of any of Aspects 1-18, further comprising transmitting, to a network entity, a scheduling request associated with the sidelink communication, wherein the scheduling request includes an identifier associated with another UE receiving the sidelink communication, wherein the resource allocation is based at least in part on the identifier associated with the other UE.

Aspect 20: The method of Aspect 19, wherein the identifier associated with the other UE is one of an RNTI or a sidelink interface identifier.

Aspect 21: A method of wireless communication performed by a network entity, comprising: transmitting, to a UE, a configuration of a first resource pool associated with a first component carrier and a second resource pool associated with a second component carrier; and transmitting, to the UE, an indication of a resource allocation associated with a sidelink communication, wherein the resource allocation is based at least in part on at least one of the first resource pool or the second resource pool.

Aspect 22: The method of Aspect 21, wherein the resource allocation is based at least in part on both the first resource pool and the second resource pool, and wherein the sidelink communication includes a duplicated communication transmitted using both the first component carrier and the second component carrier.

Aspect 23: The method of any of Aspects 21-22, wherein the sidelink communication is at least one of a groupcast communication, a broadcast communication, or a unicast communication with another UE.

Aspect 24: The method of Aspect 23, wherein the sidelink communication is the unicast communication with the other UE, and wherein the other UE is associated with an unknown carrier capability.

Aspect 25: The method of any of Aspects 21-24, wherein the resource allocation is based at least in part on a determination of whether to use the first component carrier or the second component carrier for the sidelink communication.

Aspect 26: The method of Aspect 25, wherein the determination is based at least in part a carrier capability of one or more other UEs receiving the sidelink communication.

Aspect 27: The method of Aspect 26, further comprising receiving an indication of the carrier capability of the one or more other UEs from the one or more other UEs.

Aspect 28: The method of Aspect 26, further comprising determining the carrier capability of the one or more other UEs based at least in part on an identifier associated with a transmission received from the one or more other UEs.

Aspect 29: The method of Aspect 25, wherein the determination is based at least in part on a type of an application being transmitted using the sidelink communication.

Aspect 30: The method of Aspect 25, wherein the determination is based at least in part on whether a message being transmitted using the sidelink communication is a unicast communication, a groupcast communication, or a broadcast communication.

Aspect 31: The method of Aspect 25, wherein the determination is based at least in part on at least one channel congestion parameter.

Aspect 32: The method of Aspect 31, wherein the at least one channel congestion parameter includes at least one CBR.

Aspect 33: The method of Aspect 32, wherein the at least one CBR includes a first CBR associated with the first component carrier and a second CBR associated with the second component carrier.

Aspect 34: The method of Aspect 31, further comprising: receiving, from the UE, a first channel congestion parameter associated with the first component carrier; and receiving, from the UE, a second channel congestion parameter associated with the second component carrier, wherein the determination is performed by the network entity and is based at least in part on the first channel congestion parameter and the second channel congestion parameter.

Aspect 35: The method of Aspect 31, further comprising receiving, from the UE, an indication of the determination of whether to use the first component carrier or the second component carrier for the sidelink communication, wherein the determination is performed by the UE based at least in part on the at least one channel congestion parameter, and wherein the indication of the determination does not include the at least one channel congestion parameter.

Aspect 36: The method of any of Aspects 21-35, further comprising receiving, from the UE, a scheduling request associated with the sidelink communication, wherein the scheduling request includes an indication of whether the first component carrier and the second component carrier are permitted to be used for the sidelink communication.

Aspect 37: The method of Aspect 36, wherein the indication is based at least in part on at least one of a carrier used to transmit the scheduling request, a carrier index indication provided with the scheduling request, a carrier bitmap provided with the scheduling request, or a logical channel identifier included in a buffer status report associated with the scheduling request.

Aspect 38: The method of any of Aspects 21-37, further comprising receiving, from the UE, a scheduling request associated with the sidelink communication, wherein the scheduling request includes an identifier associated with another UE receiving the sidelink communication, and wherein the resource allocation is based at least in part on the identifier associated with the other UE.

Aspect 39: The method of Aspect 38, wherein the identifier associated with the other UE is one of an RNTI or a sidelink interface identifier.

Aspect 40: An apparatus for wireless communication at a device, comprising a processor; memory coupled with the processor; and instructions stored in the memory and executable by the processor to cause the apparatus to perform the method of one or more of Aspects 1-20.

Aspect 41: A device for wireless communication, comprising a memory and one or more processors coupled to the memory, the one or more processors configured to perform the method of one or more of Aspects 1-20.

Aspect 42: An apparatus for wireless communication, comprising at least one means for performing the method of one or more of Aspects 1-20.

Aspect 43: A non-transitory computer-readable medium storing code for wireless communication, the code comprising instructions executable by a processor to perform the method of one or more of Aspects 1-20.

Aspect 44: A non-transitory computer-readable medium storing a set of instructions for wireless communication, the set of instructions comprising one or more instructions that, when executed by one or more processors of a device, cause the device to perform the method of one or more of Aspects 1-20.

Aspect 45: An apparatus for wireless communication at a device, comprising a processor; memory coupled with the processor; and instructions stored in the memory and executable by the processor to cause the apparatus to perform the method of one or more of Aspects 21-39.

Aspect 46: A device for wireless communication, comprising a memory and one or more processors coupled to the memory, the one or more processors configured to perform the method of one or more of Aspects 21-39.

Aspect 47: An apparatus for wireless communication, comprising at least one means for performing the method of one or more of Aspects 21-39.

Aspect 48: A non-transitory computer-readable medium storing code for wireless communication, the code comprising instructions executable by a processor to perform the method of one or more of Aspects 21-39.

Aspect 49: A non-transitory computer-readable medium storing a set of instructions for wireless communication, the set of instructions comprising one or more instructions that, when executed by one or more processors of a device, cause the device to perform the method of one or more of Aspects 21-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a configuration of a first resource pool associated with a first component carrier and a second resource pool associated with a second component carrier;
receive an indication of a resource allocation associated with a sidelink communication, wherein the resource allocation is based at least in part on at least one of the first resource pool or the second resource pool; and
perform the sidelink communication in accordance with the resource allocation.

2. The apparatus of claim 1, wherein the resource allocation is based at least in part on both the first resource pool and the second resource pool, and wherein performing the sidelink communication includes transmitting a duplicated communication using both the first component carrier and the second component carrier.

3. The apparatus of claim 2, wherein the sidelink communication is at least one of a groupcast communication, a broadcast communication, or a unicast communication with another UE.

4. The apparatus of claim 3, wherein the sidelink communication is the unicast communication with the other UE, and wherein the other UE is associated with an unknown carrier capability.

5. The apparatus of claim 1, wherein the resource allocation is based at least in part on a determination of whether to use the first component carrier or the second component carrier for the sidelink communication.

6. The apparatus of claim 5, wherein the determination is based at least in part a carrier capability of one or more other UEs receiving the sidelink communication.

7. The apparatus of claim 6, wherein the one or more processors are further configured to receive an indication of the carrier capability of the one or more other UEs from the one or more other UEs.

8. The apparatus of claim 6, wherein the one or more processors are further configured to determine the carrier capability of the one or more other UEs based at least in part on an identifier associated with a transmission received from the one or more other UEs.

9. The apparatus of claim 5, wherein the determination is based at least in part on a type of an application being transmitted using the sidelink communication.

10. The apparatus of claim 5, wherein the determination is based at least in part on whether a message being transmitted using the sidelink communication is a unicast communication, a groupcast communication, or a broadcast communication.

11. The apparatus of claim 5, wherein the determination is based at least in part on at least one channel congestion parameter.

12. The apparatus of claim 11, wherein the at least one channel congestion parameter includes at least one channel busy ratio (CBR).

13. The apparatus of claim 12, wherein the at least one CBR includes a first CBR associated with the first component carrier and a second CBR associated with the second component carrier.

14. The apparatus of claim 11, wherein the one or more processors are further configured to:
measure a first channel congestion parameter associated with the first component carrier; and
measure a second channel congestion parameter associated with the second component carrier, wherein the determination is based at least in part on the first channel congestion parameter and the second channel congestion parameter.

15. The apparatus of claim 14, wherein the one or more processors are further configured to transmit, to a network entity, the first channel congestion parameter and the second channel congestion parameter, wherein the determination is performed by the network entity based at least in part on the first channel congestion parameter and the second channel congestion parameter.

16. The apparatus of claim 14, wherein the one or more processors are further configured to transmit, to a network entity, an indication of the determination of whether to use the first component carrier or the second component carrier for the sidelink communication, wherein the determination is performed by the UE based at least in part on the first channel congestion parameter and the second channel congestion parameter, and wherein the indication of the determination does not include the first channel congestion parameter or the second channel congestion parameter.

17. The apparatus of claim 1, wherein the one or more processors are further configured to transmit, to a network entity, a scheduling request associated with the sidelink communication, wherein the scheduling request includes an indication of whether the first component carrier and the second component carrier are permitted to be used for the sidelink communication.

18. The apparatus of claim 17, wherein the indication is based at least in part on at least one of a carrier used to transmit the scheduling request, a carrier index indication provided with the scheduling request, a carrier bitmap provided with the scheduling request, or a logical channel identifier included in a buffer status report associated with the scheduling request.

19. The apparatus of claim 1, wherein the one or more processors are further configured to transmit, to a network entity, a scheduling request associated with the sidelink communication, wherein the scheduling request includes an identifier associated with another UE receiving the sidelink communication, wherein the resource allocation is based at least in part on the identifier associated with the other UE.

20. The apparatus of claim 19, wherein the identifier associated with the other UE is one of a radio network temporary identifier (RNTI) or a sidelink interface identifier.

21. An apparatus for wireless communication at a network entity, comprising:
a memory; and
one or more processors, coupled to the memory, configured to:
transmit, to a user equipment (UE), a configuration of a first resource pool associated with a first component carrier and a second resource pool associated with a second component carrier; and
transmit, to the UE, an indication of a resource allocation associated with a sidelink communication, wherein the resource allocation is based at least in part on at least one of the first resource pool or the second resource pool.

22. The apparatus of claim 21, wherein the resource allocation is based at least in part on both the first resource pool and the second resource pool, and wherein the sidelink communication includes a duplicated communication transmitted using both the first component carrier and the second component carrier.

23. The apparatus of claim 21, wherein the resource allocation is based at least in part on a determination of whether to use the first component carrier or the second component carrier for the sidelink communication.

24. The apparatus of claim 21, wherein the one or more processors are further configured to receive, from the UE, a scheduling request associated with the sidelink communication, wherein the scheduling request includes an indication of whether the first component carrier and the second component carrier are permitted to be used for the sidelink communication.

25. The apparatus of claim 21, wherein the one or more processors are further configured to receive, from the UE, a scheduling request associated with the sidelink communication, wherein the scheduling request includes an identifier associated with another UE receiving the sidelink communication, and wherein the resource allocation is based at least in part on the identifier associated with the other UE.

26. A method of wireless communication performed by a user equipment (UE), comprising:
receiving a configuration of a first resource pool associated with a first component carrier and a second resource pool associated with a second component carrier;
receiving an indication of a resource allocation associated with a sidelink communication, wherein the resource allocation is based at least in part on at least one of the first resource pool or the second resource pool; and
performing the sidelink communication in accordance with the resource allocation.

27. The method of claim 26, wherein the resource allocation is based at least in part on both the first resource pool and the second resource pool, and wherein performing the sidelink communication includes transmitting a duplicated communication using both the first component carrier and the second component carrier.

28. The method of claim 26, wherein the resource allocation is based at least in part on a determination of whether to use the first component carrier or the second component carrier for the sidelink communication.

29. A method of wireless communication performed by a network entity, comprising:
transmitting, to a user equipment (UE), a configuration of a first resource pool associated with a first component carrier and a second resource pool associated with a second component carrier; and
transmitting, to the UE, an indication of a resource allocation associated with a sidelink communication, wherein the resource allocation is based at least in part on at least one of the first resource pool or the second resource pool.

30. The method of claim 29, wherein the resource allocation is based at least in part on a determination of whether to use the first component carrier or the second component carrier for the sidelink communication.
